(19) United States
(12) Patent Application Publication
(10) Pub. No.: US 2018/0291631 A1
(43) Pub. Date: Oct. 11, 2018

(54) Deep Well Daylight Harvesting System with Light Emitting Diodes Using Solar Generated Power

(71) Applicant: Anthony Lawrence Chirico, Essex, CT (US)

(72) Inventor: Anthony Lawrence Chirico, Essex, CT (US)

(21) Appl. No.: 15/481,899

(22) Filed: Apr. 7, 2017

(30) Foreign Application Priority Data
Apr. 7, 2017 (US) 15481899

(51) Int. Cl. E04D 13/03; F21S 8/04

(52) U.S. Cl. CPC E04D 13/033; F21S 9/037; F21S 8/04

(57) ABSTRACT

A versatile length, deep well skylight, with supplementary light emitting diodes, that are powered by a back-up battery, charged by the sun. This green energy unit is self-contained and saves the cost of primary power. It is dual domed which attracts solar rays which are then reflected through a mirror polished aluminum interior. The light is then diffused through a lower lens to produce cool, even light in the structure interior.

The rim of the upper lens houses multiple solar panels which collect the solar energy for the battery back-up. The battery back-up provides the energy to the light emitting diodes through the inverter which converts the direct current electricity to alternating current electricity and then through the driver which in turn produces light from the light emitting diodes.

Light which is produced directly from the sun and/or indirectly through the light emitting diodes is then reflected through the deep well, mirror polished aluminum interior to the diffuser. The lower lens or diffuser spreads the light evenly across the interior of the structure. The unit is thermal neutral and designed for leak-proof installation. It is also designed for simple, easy maintenance with snap in parts and a hinged lower lens.

### RELATED APPLICATION

This application claims the benefit of U.S. Provisional Application No. 62/358,209

### FIELD OF THE INVENTION

This invention is an improvement in daylighting systems. SunShine III is a deep well, self-contained, green energy product that harvests daylight which provides uniform cool lighting through a diffuser lens. The unit also delivers light through light emitting diodes powered by a solar charged battery for night time use. It is thermally neutral and has a leak-proof installation design.

### BACKGROUND OF THE INVENTION

Man has recognized the benefits of daylight since the beginning of time. There is evidence that cavemen dug holes in their roofs to allow the rays of the sun into their dwellings. Daylighting systems have evolved over time from these simple holes to the modern, technically efficient, energy saving Sunshine III Daylighting System.

Early skylights were not much more than the hole in the roof being covered with a transparent material. It wasn't until Weisner (1982) U.S. Pat. No. 4,344,261, that the discussion turned to the use of a diffuser to spread the passive light evenly into the structure. Green (1996) U.S. Pat. No. 5,528,471 introduced the use of fluorescent lights and added the use of artificial light to a previously passive system. Han (2000) U.S. Pat. No. 6,142,645 changed the basic structure of the units from square and angular to round. Ghandi (2005) U.S. Pat. No. 7,313,295 added reflectors to the artificial light and increased the overall performance. Zincone in 2006, U.S. Pat. No. 7,057,821, made major changes in daylighting systems with the introduction of light emitting diodes powered by a rechargeable battery from a photovoltaic cell. The introduction of cylindrical refractors by Brancale (2007) Patent No. 20120134170 furthered the discussion. Levens (2010) U.S. Pat. No. 8,585,269, added multiple diffusers to enhance unit performance. Rillie, et al. (2009) Patent No. 20090113824 added the use of a directional diffuser to reflect light off walls and ceilings. Zincone, et al. (2013) U.S. Pat. No. 8,585,269 introduced the use of a thermal barrier and an integrated curb system to improve the installation process.

While there has been dramatic improvement in daylighting systems in recent years, there is room to further enhance these units to achieve greater efficiency and flexibility. SunShine III is such a unit and stands ready to take its place in the market of daylighting systems.

### SUMMARY OF THE INVENTION

Ameri Sunshine Daylighting System III is a solar based, stand-alone, daylighting harvesting system bringing outdoor light into a building. The unit utilizes day light to illuminate and solar panels located on the upper frame to power the integrated LED system for low light or night time use, and is run by battery backup.

### BRIEF DESCRIPTION OF THE DRAWINGS

FIG. 1 Exploded Axonometric View

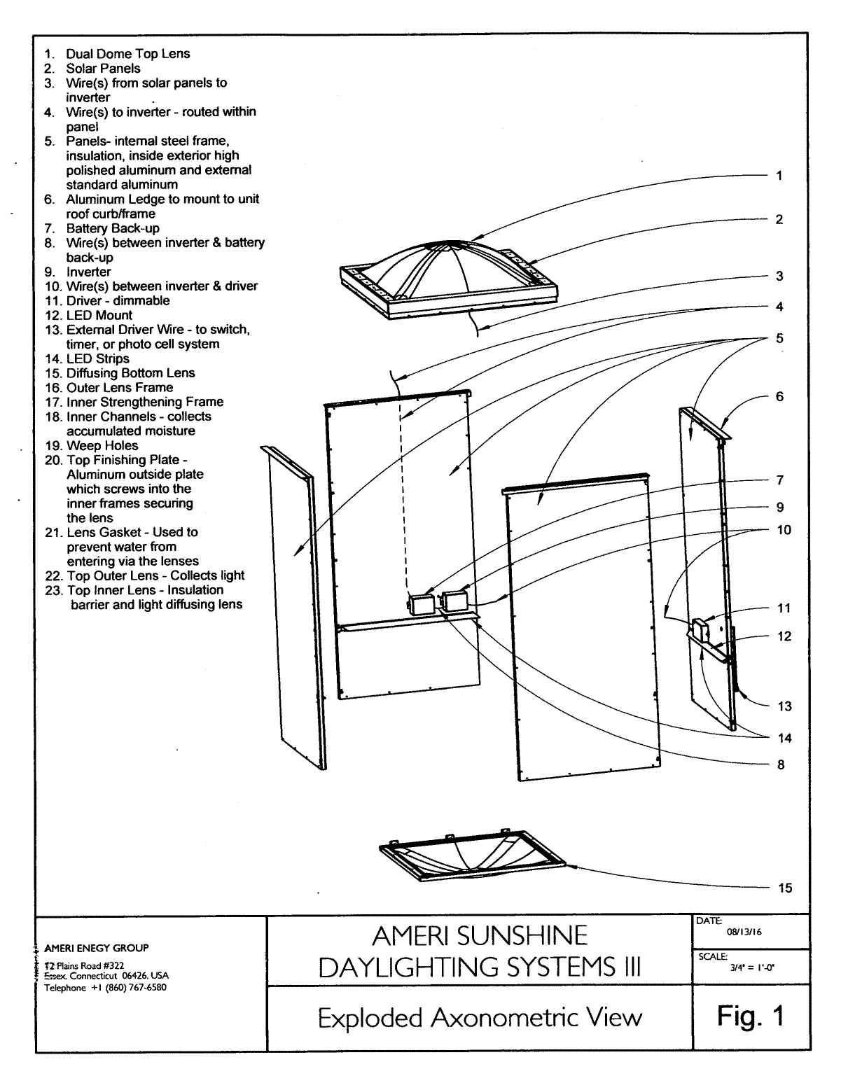

FIG. 2 Sectional View

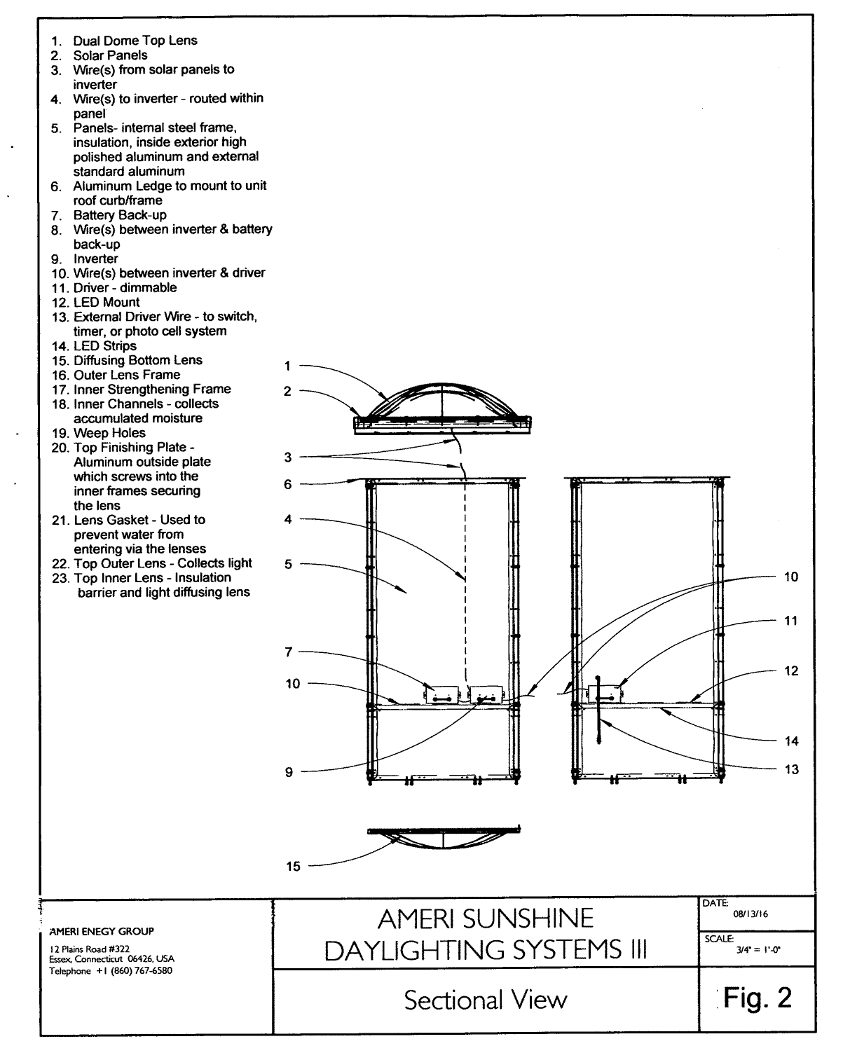

FIG. 3 Exploded Axonometric—Rear

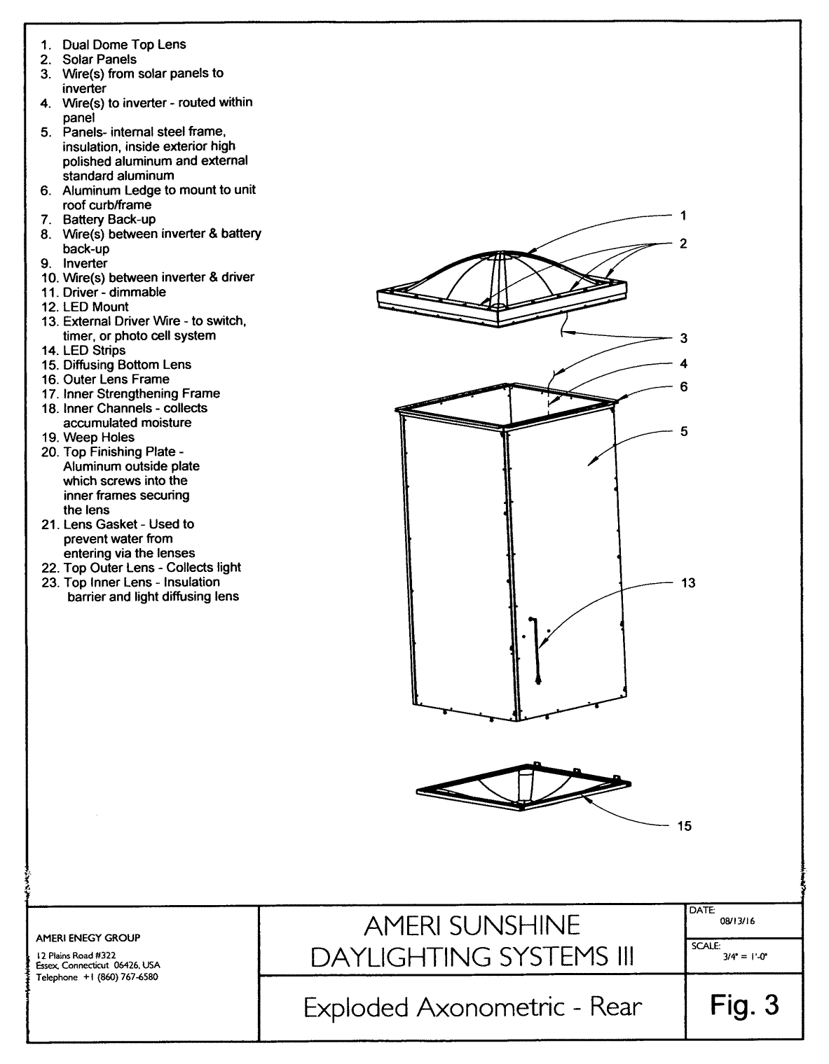

FIG. 4 Lens Plan and Elevations

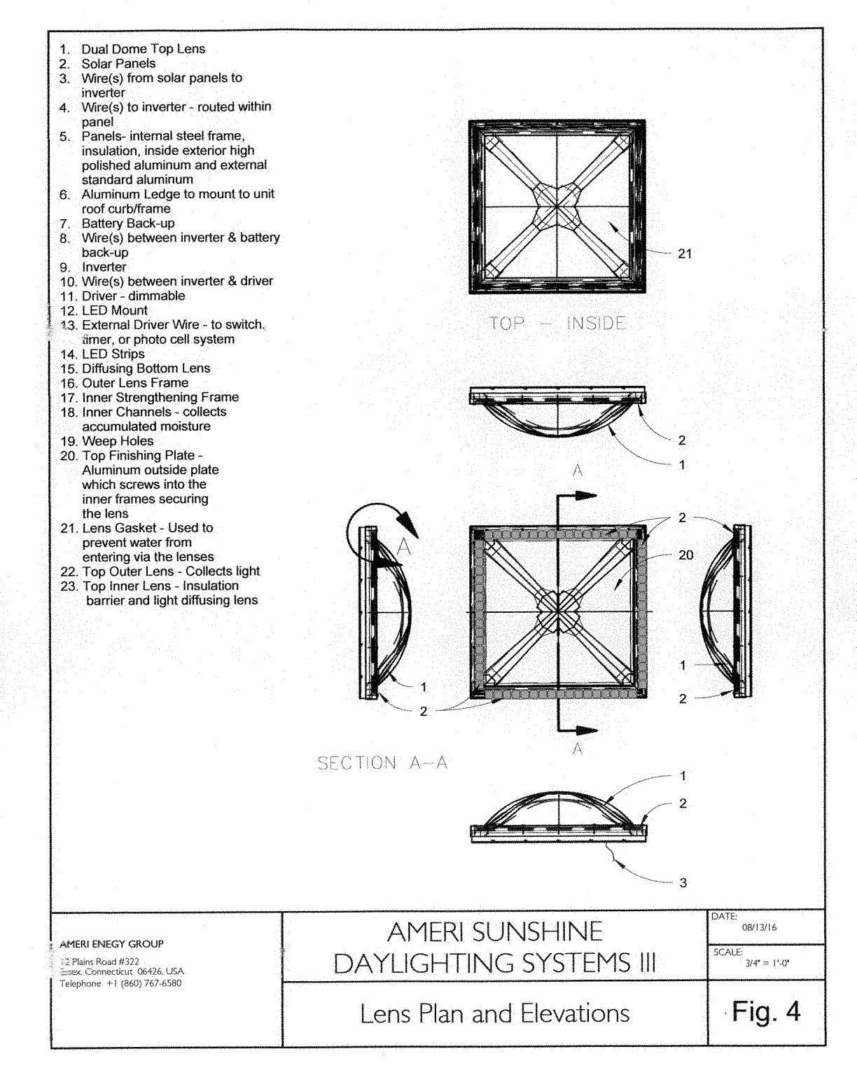

FIG. 5 Lens Cover Details

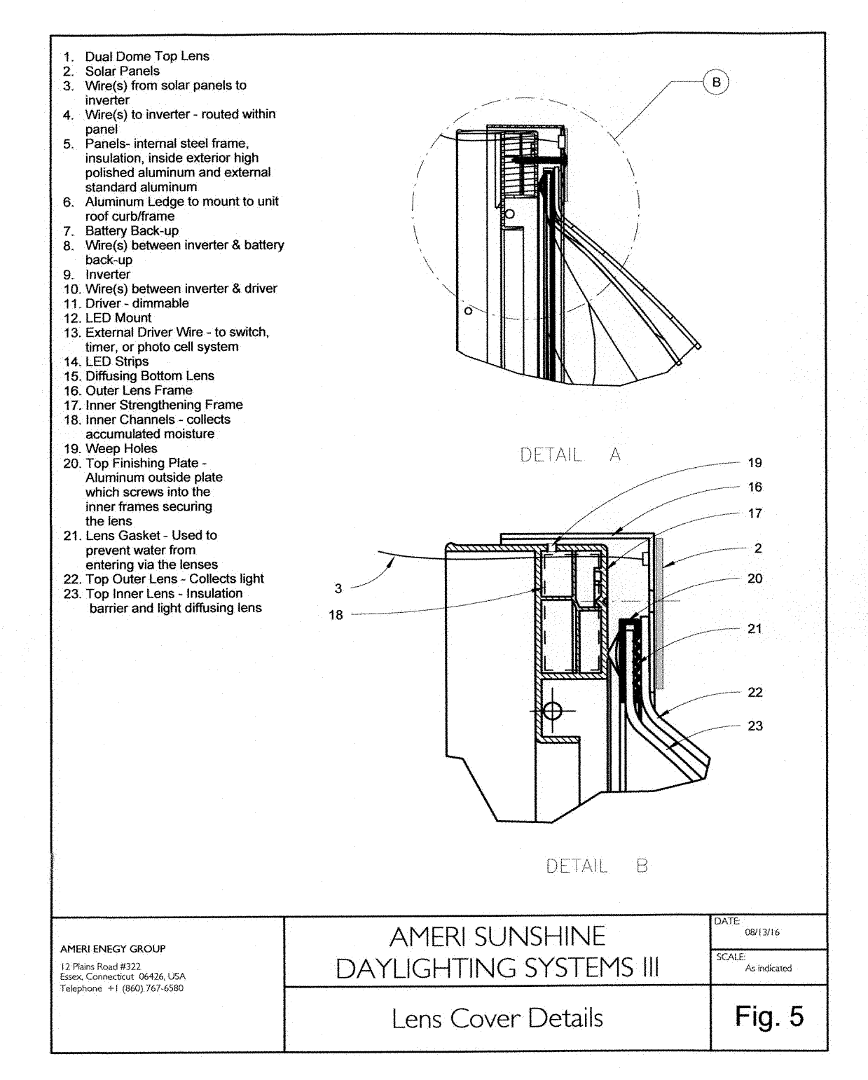

### DETAILED DESCRIPTION OF THE PREFERRED EMBODIMENTS

Special curved, dual top lenses attract light from all directions. The pseudo-elliptical lens design collects daylight, funneling and dispersing beams of light into the shaft of highly polished aluminum walls that reflect and intensify the light. The dual top lens also serves as an insulation barrier and internal lens disperses light evenly into the deep well preventing hot spots. The square design reduces loss of light rays bouncing from wall to wall. The bottom lens is a special diffuser that disperses the light evenly onto the floor. Inside is a modular LED light system for low light or night time use. The LED strips are positioned to utilize the reflective aluminum in the same manner as daylight from outside. The solar panels, located on the top lens frame, generate and store energy to be used during low light or night use when the LEDs are active.

Sunshine units are well sealed at the roof and there are no limitations on the building structure. It can be installed on any roof pitch.

The units are made of the highest quality polished aluminum and metal alloys and measure 2 feet×2 feet and can be from a depth of 2 to 12 feet.

Sunshine III utilizes the newest LED/Driver technology with options of 50 or 100 watts

The unit weight 66 pounds, has a fireproof rating of B1, a lens UV protection rating of 3 and is IP 67-totally protected against dust and immersion.

There is minimum to no maintenance cost and there is easy access to all parts. Components are snap on and off for replacements. The hinged bottom lens allows for easy access to the inside unit. The unit is UL and CE certified.

1. Dual Dome Top Lens—captures light from all angles in any weather condition while also providing thermal barrier to maintain the unit's thermal neutrality and UV protected.
2. Solar Panels—collect solar energy for the battery back-up
3. Wire(s) from solar panels to inverter
4. Wire(s) to inverter—routed within panel
5. Panels—internal steel frame, insulation, inside exterior high polished aluminum and external standard aluminum
6. Aluminum Ledge to mount to unit roof curb/frame
7. Battery Back-up—provides energy for LED's as needed
8. Wire(s) between inverter & battery back-up
9. Inverter—converts DC to AC
10. Wire(s) between inverter & driver
11. Driver—dimmable
12. LED Mount—holds LED's
13. External Driver Wire—to switch, timer, or photo cell system
14. LED Strips—when natural light diminishes the system utilize LED's to replace that light and regulate LUX output to the interior.
15. Diffusing Bottom Lens—provides glare free natural light to the interior while also screening out the more harmful spectrums of sunlight.
16. Outer Lens Frame—provides support
17. Inner Strengthening Frame—provides greater support
18. Inner Channels—collects accumulated moisture
19. Weep Holes—drainage allowance
20. Top Finishing Plate—Aluminum outside plate which screws into the inner frames securing the lens
21. Lens Gasket—Used to prevent water from entering via the lenses
22. Top Outer Lens—Collects light
23. Top Inner Lens—Insulation barrier and light diffusing lens
24. Breakout A—Detail Outer lens frame
25. Breakout B—Detail Upper lens gasket

### Materials

### Part Description Specs

Top lens frame Aluminum alloy 5052 H32, T=1.6

Top outside lens Acrylic (MISUBISHI)+UV, T=3

Top inside lens Acrylic (MISUBISHI)+UV, T=3

Top inside lens frame White PVC+UV, soft white PVC

Inside panel Single surface mirror aluminum sheet, T=0.5

Outside panel Aluminum 6063, T=0.5

Bottom lens frame Al alloy 6063

Bottom lens Acrylic (MISUBISHI)+UV, T=3, Satin or Clear Finish

Hinge (for bottom lens) Stainless steel 304, T=1

Curb plates Aluminum 5052 H32, T=1.6

Curb inside top edge border Treated Wood

Curb shoe Aluminum 5052 H32, T=1.6

Power Supply Output Voltage is 32 Vdc, Output current is 1400 mA, Output Power is 44.8 W

Input Voltage is 120 Vac to 277 Vac.

Efficiency is around 87% and both TRIAC & 0-10V dimmable.

LED Strips 4 strips, 2 feet long each, LED bulbs natural white to warm white 2700 k to 5000 k

Fasteners Exposed fasteners shall be stainless steel or zinc coated

Thermal Insulation Material Fireproof rating B1

1. (canceled)

2. A skylight, comprising:
a deep well comprising a first end, a second end opposite to said first end, and four panels positioned between said first end and said second end, said panels configured to form a square cross-section between said first end and said second end, said panels being coated with a reflective material;
a dual-top lens connected to the first end, said dual-top lens comprising a first lens and a second lens, said second lens positioned between said first lens and the first end of the deep well;
a bottom lens operatively connected to the second end of the deep well;
a battery;
at least one solar panel operatively connected to said battery and configured to charge said battery when exposed to sunlight; and
at least one light emitting diode operatively connected to said battery and configured to provide light when receiving electricity from said battery.

3. The deep well skylight of claim 2, further comprising an inverter and at least one driver, the at least one light emitting diode operatively connected to the battery through said inverter and said at least one driver, said inverter configured to convert direct current to alternating current and said driver configured to cause the at least one light emitting diode to emit light.

4. The deep well skylight of claim 2, further comprising a top lens frame, said top lens frame comprising at least one channel and at least one weep hole, said at least one channel and at least one weep hole configured to remove accumulated moisture, said top lens frame mounted to the first end of the deep well, the dual-top lens connected to said top lens frame whereby the dual-top lens is connected to the first end of the deep well.

5. The deep well skylight of claim 4, wherein said at least one solar panel is located on the top lens frame on a side distal from the second end of the deep well and outside of said dual-top lens above the dual-top lens.

6. The deep well skylight of claim 2, wherein said bottom lens is a diffusing lens.

7. The deep well skylight of claim 6, wherein said bottom lens is configured to filter out at least a portion of the ultraviolet spectrum from passing through said bottom lens.

8. The deep well skylight of claim 2, wherein said bottom lens is operatively connected to the second end of the deep well skylight by a hinge.

9. The deep well skylight of claim 2, wherein the first lens of the dual-top lens is a pseudo-elliptical lens.

10. The deep well skylight of claim 2, wherein the second lens of the dual-top lens is a diffusing lens.

11. The deep well skylight of claim 2, wherein the dual-top lens further comprises an air gap between said first lens and said second lens.

12. The deep well skylight of claim 2, wherein said first lens and said second lens of the dual-top lens are dome-shaped.

13. The deep well skylight of claim 2, wherein said first lens is configured to filter out at least a portion of the ultraviolet spectrum from passing through said first lens.

14. The deep well skylight of claim 2, wherein said second lens is configured to filter out at least a portion of the ultraviolet spectrum from passing through said second lens

15. The deep well skylight of claim 2, further comprising a lens gasket operatively connected to said dual-top lens and configured to prevent water penetration into the deep well or the dual-top lens.

16. The deep well skylight of claim 2, wherein said deep well skylight is thermally neutral.

17. The deep well skylight of claim 2, wherein said deep well skylight does not comprise a heat exchanger and is not operatively connected to a heat exchanger.

18. The deep well skylight of claim 2, wherein each of the four panels of the deep well are insulated.

19. The deep well skylight of claim 2, wherein said at least one driver is operatively connected to a controller configured to activate or deactivate the at least one light emitting diode via said at least one driver.

20. A deep well skylight, comprising:
a deep well comprising a first end, a second end opposite to said first end, and four panels positioned between said first end and said second end, said panels configured to form a square cross-section between said first end and said second end, said panels being coated with a reflective material and said panels being insulated;
a top lens frame mounted on the first end of said deep well, said top lens frame comprising at least one channel and at least one weep hole, said at least one channel and at least one weep hole configured to remove accumulated moisture;
a dual-top lens mounted in said top lens frame comprising a first lens, a second lens and an air gap between said first lens and said second lens, said second lens positioned between said first lens and the first end of the deep well, said first lens and said second lens being dome-shaped, said second lens a diffusing lens;
a lens gasket operatively connected to said dual-top lens and configured to prevent water penetration into the deep well or the dual-top lens;
a bottom lens operatively connected to the second end of the deep well, said bottom lens being a diffusing lens;
a battery;
at least one solar panel operatively connected to said battery and configured to charge said battery when exposed to sunlight, said at least one solar panel positioned on said top lens frame outside of said dual-top lens;
an inverter and at least one driver; and
at least one light emitting diode operatively connected to the battery through said inverter and said at least one driver, said inverter configured to convert direct current to alternating current and said driver configured to cause the at least one light emitting diode to emit light;
wherein said deep well skylight is thermally neutral.

21. A deep well skylight, comprising:
a deep well comprising a first end, a second end opposite to said first end, and four panels positioned between said first end and said second end, said panels configured to form a square cross-section between said first end and said second end, said panels being coated with a reflective material and said panels being insulated;
a top lens frame mounted on the first end of said deep well, said top lens frame comprising at least one channel and at least one weep hole, said at least one channel and at least one weep hole configured to remove accumulated moisture;
a dual-top lens mounted in said top lens frame comprising a first lens, a second lens and an air gap between said first lens and said second lens, said second lens positioned between said first lens and the first end of the deep well, said first lens and said second lens being dome-shaped, said second lens a diffusing lens, said first lens being configured to filter out at least a portion of the ultraviolet spectrum from passing through said first lens;
a lens gasket operatively connected to said dual-top lens and configured to prevent water penetration into the deep well or the dual-top lens;
a bottom lens operatively connected to the second end of the deep well, said bottom lens being a diffusing lens, said bottom lens being configured to filter out at least a portion of the ultraviolet spectrum from passing through said bottom lens;
a battery;
at least one solar panel operatively connected to said battery and configured to charge said battery when exposed to sunlight, said at least one solar panel positioned on said top lens frame outside of said dual-top lens;
an inverter and at least one driver; and
at least one light emitting diode operatively connected to the battery through said inverter and said at least one driver, said inverter configured to convert direct current to alternating current and said driver configured to cause the at least one light emitting diode to emit light;
wherein said deep well skylight does not comprise a heat exchanger and is not operatively connected to a heat exchanger, and wherein said deep well skylight is thermally neutral.
